(19) United States
(12) Patent Application Publication
(10) Pub. No.: US 2024/0410056 A1
(43) Pub. Date: Dec. 12, 2024

(54) METHOD AND A DEVICE FOR APPLYING A METALLIC COATING TO A SURFACE

(71) Applicant: MIDNEX AG, Bremgarten (CH)

(72) Inventors: Walter Randolf Ernst HOFFMANN, Clausthal-Zellerfeld (DE); Manfred HELLMICH, Osterode (DE); Wolfgang Otto Rudi PILSTER, Seesen (DE)

(21) Appl. No.: 18/273,952

(22) PCT Filed: Jan. 29, 2021
(86) PCT No.: PCT/EP2021/052112

§ 371 Date: Jul. 24, 2023

(51) Int. Cl. C23C 18/14; C23C 18/04; C23C 18/06; C23C 18/08; C23C 28/02

(52) U.S. Cl. CPC C23C 18/14; C23C 18/04; C23C 18/06; C23C 18/08; C23C 28/02

(57) ABSTRACT

A method for applying a metallic coating to a surface of a substrate, in particular for producing conductor tracks includes applying ink to a location to be coated of the surface, the ink including at least one metal salt of an organic acid or a mixture of such salts, and decomposing the ink by supplying energy to the ink, thereby generating the metallic coating from the metal salt or the metal salts, the metallic coating adhering to the surface at the location to be coated.

### CROSS-REFERENCE TO RELATED APPLICATION

This application is a U.S. National Stage application of PCT/EP2021/052112, filed Jan. 29, 2021, the contents of which are hereby incorporated by reference.

### BACKGROUND

### Technical Field

The disclosure relates to a method and a device for applying a metallic coating to a surface of a substrate, such as a plastic substrate or ceramic substrate, and to an ink for use in such a method or such a device, wherein the application can be used in particular to produce conductor tracks.

### Background Information

In order to enable the metallization of plastic surfaces, these surfaces normally have to be changed or activated to enable the deposition and adhesion of metallic particles/coatings on the surface. The technology of laser direct structuring (LDS technology) has proven particularly suitable for the metallization and thus functionalization of non-planar components. In these methods, plastics that are not directly suitable for galvanic deposition of metals are made coatable by a primer. An additive is added to the plastic used to produce the desired components in the injection molding process. This additive can be, for example, copper-containing minerals or a palladium-based compound. In order to be able to galvanize the material after shaping, the surface of the component is damaged specifically by a laser where the metallic deposition is to be performed. Due to the damage of the surface, palladium nuclei or the copper contained in the mineral are released, which in each case form crystal nuclei in the subsequent galvanic process at which the deposition takes place. However, one disadvantage of the LDS method is that it is relatively error-prone.

DE 102008027461 B4 discloses a device and a method for micro-structuring a plastic film by a roller using a plasma. In this process, micro-structured indentations are created on the surface, which are then wet-chemically metallized to produce conductor tracks.

From EP 2674223 B1, a device for the production of conductor tracks by a powder mixture is known. In this process, a plasma is used to melt a matrix material in which a substance is embedded that is to adhere to a substrate.

EP 2711441 BL also discloses a method for coating a substrate by a plasma. Here, a powder is also used as the starting material.

From DE 19958473 A 1 it is known to use a plasma to modify precursor materials and subsequently deposit them on a substrate. The precursor materials can be liquids, in particular a suspension, which can also contain nanoscale particles of metals. However, the precursor materials are fed directly to the plasma jet source. In addition, it is not disclosed to change the surface of the substrate, in particular not to make a change where the metallic precursor material is to be applied. The production of conductor tracks on surfaces is not described.

JP 2020004648 A describes a method for conductor track generation by an ink containing copper oxides and which are reduced to copper by plasma treatment under a reducing atmosphere. Furthermore, in this method oxygen in high concentration is used to remove the ink to the extent that the metal particles remain.

In CN 107148154 A, a method is described for the production of conductor tracks on substrates which are pretreated by a plasma. Subsequently, an ink containing a catalytic salt is then applied. After curing of the ink, the exposed metal ions are reduced and form the basis for a chemical copper deposition in a classical bath, wherein formaldehyde is used as a reducing agent.

From WO 2008077608 A2 a method and a device for spraying a conductor track by a lance, which generates a cold plasma and delivers a powder, are known.

### SUMMARY

The disclosure is based on the object of providing a method of the type mentioned above, by which a simplified coating of a surface with a metal is made possible. In particular, a method is to be made available in which no additivation of the substrate, such as a plastic raw material, is required and which allows a plurality of different materials, such as plastics or also ceramics, to be metallized. Furthermore, the disclosure is based on the object of providing a print head for a device for performing the method. Finally, the disclosure is based on the object of proposing a substance which can be used in particular in such a method and in such a device and which is particularly suitable in particular for coating a plastic surface or ceramic surface with a metal.

The object relating to the method is met by the features of disclosed herein. For this purpose, an ink is applied to a location to be coated of the surface. The application can take place out from a nozzle by ejecting the ink towards the surface. Alternatively, the ink can also be applied to the location to be coated or the surface, for example, by dipping the substrate into the ink and/or by brushing or pipetting the ink onto the substrate. Of course, the method according to the disclosure can also be performed at several locations on the surface to be coated.

The ink contains at least one metal salt of an organic acid. The metal cation or, in the case of multiple salts, the metal cations are selected or intended to form the metallic coating to be applied. In particular, the coating can form in the form of metallic particles. Preferably, however, a continuous and/or homogeneous coating is formed. A further step of the method according to the disclosure includes decomposing the ink by supplying energy to it. The decomposition of the ink results in particular in a decomposition of the at least one salt, whereby the at least one metal forms the metallic coating on the surface.

During decomposition, the metal salt of the organic acid decomposes in particular into easily removable decomposition products such as water and carbon dioxide, wherein metal cations are reduced to an elemental metal which remains on the location to be coated and thus on the surface. Since the decomposition products are easily removable, a simplified application of a metal coating is made possible without the need for time-consuming removal of decomposition products.

In a particularly preferred embodiment, the substrate is a plastic substrate or ceramic substrate. Here, the surface to be provided with the metal coating is preferably prepared by roughening the surface at the location to be coated, provided this location does not have a roughness from the first. This pretreatment or the already existing roughness ensures that the metal coating will adhere to the surface. A sufficient roughness is achieved as soon as the metal coating adheres to the surface.

However, the substrate is not limited to a plastic substrate and/or ceramic substrate and could also comprise a metal, for example. In addition, the substrate could be a metal substrate or a cermet (i.e., a composite of ceramic materials in a metallic matrix), so that preparation (i.e., roughening or even cleaning) of the locations to be coated is not necessary. A roughness is not advantageous for all types of substrates since other interactions can also lead to sufficient adhesion of the coating to the surface.

In the present disclosure, the term “ink” describes a liquid which contains at least one metal salt. Depending on the metal salt and a possibly additionally contained solvent, the liquid can be thin to pasty. The term “roughness” describes in particular unevenness in a surface height of the surface and can be determined inter alia by rugo test, profile method, confocal microscopy, conoscopic holography, focus variation or white-light interferometry. Areal surface roughness measurement is described in ISO 256178.

An advantage of one embodiment of the disclosure is that many different plastic materials, such as polyethylene, polyester, or epoxy resins, can be used for the plastic substrate and, in particular, no costly additivation of the plastic raw material is required. In principle, the method according to the disclosure is suitable for any metal salt of an organic acid that can be decomposed to the coating of the elemental metal by supplying energy. Therefore, a number of different metal coatings or even metal particles can be applied to different surfaces such as plastic surfaces.

The roughness of the surface in particular ensures that it can be coated. The roughening can be done before the ink is ejected. In particular, roughening can be performed by sand blasting or glass blasting or etching. Other methods are also possible. By roughening, the surface to be treated is provided with indentations (cavities), in which a metallic layer is created in the subsequent coating process, which mechanically hooks onto or anchors itself in the plastic substrate or ceramic substrate.

However, roughening can also take place during ejection of the ink, i.e., immediately before the moment of impact of the ink on the surface. In this case, energy is supplied to the surface.

For example, this can take place by a laser. The laser creates cavities in the surface in which the metal coating generated in the subsequent process is deposited, which can serve as a crystal nucleus in a possibly provided further coating enhancement process (in particular, metallic particles in the coating). These cavities have a diameter of a few micrometers, so that the layer growing in a subsequent galvanic process closes the cavities and can thus form a closed surface. The cavities can be arranged by the direction of the laser beam in such a way that undercuts, or material bridges are formed, which increase the mechanical adherence (mechanical adhesion) of the layer or layers to be deposited on the component with the surface to be coated.

The energy supply can also be performed by generating a plasma, which simultaneously chemically activates the surface. The generation of the plasma means that an ionized, energetically highly charged gas migrates over the surface or is in contact with the surface. In the process, a plurality of chemical reactions take place that separate various atoms, atomic groups, or molecular groups from the plastic surface, and thus leave behind reactive species and reduce the surface tension, which leads to improved wetting of the surface with the ink.

The energy supply can also be performed by a flame, in particular an oxyhydrogen flame. In this case, the surface to be treated is briefly flamed. Experiments have shown that this results in roughening of the surface. However, the underlying mechanism is still unclear.

The ink can be ejected in diluted form, wherein the nozzle causes a fine atomization of the ink, or the ink can be ejected from the nozzle in the form of droplets. Suitable solvents are nonpolar or only weakly polar organic solvents such as alkanes, aromatic solvents, acetone, or isopropanol, which dissolve the organic anion of the ink used well. Preferably, isopropanol can be used, as it dissolves the inks used well and has little or no hazard potential for humans, the environment and plant technology. When a diluted ink is used, the surface to be treated preferably has a temperature of 50° C. to 60° C. during ink ejection. The surface can thus be heated specifically to this temperature. When using a flame for roughening, such heating can also be provided as a further aim. Such a temperature of the surface allows a rapid evaporation of the solvent. A fine atomization of the diluted ink through a corresponding nozzle is achieved by a process gas under excess pressure, for example compressed air or dry nitrogen. The ink must have a suitable viscosity for this.

If the metal laver to be deposited is to be achieved mainly by a galvanic post-treatment, highly diluted inks can be used. i.e., inks in which the ratio of ink to solvent is less than 1/100. This is because in this case the aim is not to achieve a closed metal layer on the surface by the decomposition of the ink alone, but only the deposition of crystal nuclei for a subsequent layer build-up by galvanizing.

Alternatively, the ink can also be ejected in undiluted form, wherein the viscosity of the ink must be adapted to the nozzle or the ejection from the nozzle must occur under high pressure. To adapt the viscosity of the ink to the nozzle, the ink can be heated such that its temperature is slightly below its decomposition temperature. In particular, the heating can be done to 10° C. to 15° C. below the decomposition temperature.

The decomposition of the ink to create the metallic coating on the surface is basically done by supplying energy, as mentioned above. The decomposition can take place between the ejection of the ink from the nozzle and its impact on the surface. However, it can also take place after the ink has impacted the surface. The decomposition temperature is approximately 250° C. For many plastics, this temperature is higher than the melting or decomposition temperature of the plastic used. It is therefore advantageous to supply the energy in the smallest possible doses at the highest possible energy density. In this way, it is ensured that the plastic surface is damaged as little as possible, unless the intention is to deliberately cause damage in order to anchor the metallic coating in the plastic.

The energy supply for the decomposition of the ink can take place by a flame. The heat of the flame decomposes the ink, so that a metallic layer remains on the surface. Here, it has been shown that an oxyhydrogen flame which emits from a flame nozzle with a diameter of less than 2 mm gives good results. Such a flame nozzle can easily be integrated into a print head that ejects the ink and follow the ink application. It has been shown that the angle taken by the flame to the surface has no small influence on the coating result. Particularly good results are achieved when the flame is at an acute angle with the surface.

The decomposition of the ink can also take place by supplying energy by electro-magnetic radiation. In this case, the radiation should be adapted to the absorption spectrum of the ink used. In the case of using copper neodecanoate as ink, the radiation should preferably have a wavelength of 620 nm to 850 nm, since said ink has appreciable absorption in this range. An ink decomposition can take place due to radiation adapted in this way, while the surface to be coated suffers practically no damage.

Another possibility to supply energy for ink decomposition is the generation of a plasma. A plasma is particularly suitable for decomposing the ink if it has been applied to the surface of the substrate in a very thin layer thickness. That is because after a decomposition of the ink in a low-pressure plasma, crystal nuclei remain from the ink, which can be easily metallized in a possible subsequent galvanic process. The use of an atmospheric plasma, namely an arc plasma or a DBD plasma (Dielectric Barrier Discharge Plasma), also known as “silent electric discharge”, is also possible and offers the advantage of a relatively gentle energy supply. Here, the viscosity of the ink is first greatly reduced so that it begins to flow, which is why it can be advantageous to use stencils to achieve the required contour sharpness.

Furthermore, heated process gas can also be used to decompose the ink. Any process gas can be used here, in particular also hot air.

Preferably, the nozzle used has an application lance with a movable nozzle tip. Such an application lance can be used in particular when diluted ink is used. For example, the interior of a hollow sphere can be coated through a small, easily closeable opening with such an application lance. For this purpose, the application lance is first inserted through the opening in the hollow sphere and then the nozzle tip is angled accordingly to be able to reach all locations of the hollow sphere. Depending on the size of the sphere or the cavity, it can be necessary to angle or bend the lance at several locations to ensure complete accessibility of the inner surface of the sphere.

Preferably, the salt containing the metal to be applied is a metal salt of a carboxylic acid or metal salts of a mixture of carboxylic acids. Here, the carboxylic acids preferably have 2 to 20 carbon atoms, in particular 4 to 16 carbon atoms, even more preferably 6 to 14 carbon atoms, in particular 8 to 12 carbon atoms and most preferably 10 carbon atoms, and can be unbranched or branched, such as dialkyl carboxylic acids or trialkyl carboxylic acids. The carboxylic acids are preferably monocarboxylic acids, but di- or tricarboxylic acids can also be used. Furthermore, the carboxylic acids can be saturated or unsaturated, wherein unsaturated carboxylic acids are preferred.

Even more preferably, it is a metal salt of neodecanoic acid. Neodecanoic acid is a mixture of branched saturated monocarboxylic acids each having 10 carbon atoms of different structure, in particular a mixture of 2,2,3,5-tetramethylhexanoic acid, 2,4-dimethyl-2-isopropylpentanoic acid, 2,5-dimethyl-2-ethylhexanoic acid, 2,2-dimethyloctanoic acid and 2,2-diethylhexanoic acid. A salt of this type decomposes particularly well when energy is supplied. As a result of the decomposition of the ink, it breaks down into the respective metal as well as the further decomposition products water and carbon dioxide or their precursors depending on the surrounding atmosphere.

Preferably, the metal contained in the metal salts is a metal commonly used in the electronics industry, such as copper, manganese, nickel, niobium, molybdenum, or yttrium. Gold, silver, or palladium salts can also be used.

The copper salt of neodecanoic acid, i.e., copper neodecanoate, has proved to be particularly suitable. However, other metal salts of neodecanoic acid can also be used, such as its manganese or nickel salt.

The selection of the ink composition is important with regard to the layer thickness to be deposited on the surface during a complete discharge cycle of the ink and with regard to the layer composition to be deposited. Both parameters are usually modified simultaneously for the particular application.

The desired thickness of the layer to be deposited should be considered with respect to the composition of the ink. In this case, it should be considered whether the metallic layer is to be produced either by the decomposition of the ink alone or with galvanic post-strengthening. The selection of the method depends on the respective application and represents a compromise between production speed and production quantity.

If the layer to be deposited is to take place solely by the decomposition of the ink, the concentration of the ink must be selected accordingly such that the ink layer produced on the surface by the ejection of the ink from the nozzle consists of closely spaced particles or consists of a homogeneous coating, or that the ink is present as a closed film on the surface after evaporation of any solvent that can be present. During the decomposition of the ink, only a certain proportion of the metal salt present is converted into the remaining metal, depending on the metal or cation used. In the case of using copper neodecanoate, this proportion is only about 15%. This results from the relation of the molar masses of copper and copper neodecanoate, whereby the charge of the ion of the metal to be deposited also enters.

When using different metal salts simultaneously, the deposition of alloys, such as constantan, a copper-nickel-manganese alloy is also possible. In particular, mixtures of the metal salts can thus be used, for example, a mixture of copper neodecanoate, nickel neodecanoate and manganese neodecanoate, to produce the metal layer as an alloy. The composition of the alloy can then be easily controlled by the composition of the ink. Layer combinations can also be produced by alternately applying different metal salts.

The metallic lavers produced on the surface will reach a certain thickness depending on the application situation. If this thickness is below the desired thickness, the existing layer can be reinforced. This can be done by repeating the process steps carried out. It can also be provided that a further metal from a corresponding galvanic bath without externally applied current is deposited on the existing layer, wherein the already deposited metallic coating serves as a crystal nucleus. The thickness of the metallic layer can be achieved by adapting an amount of the metal salt of the organic acid or by changing a concentration of the metal salt of the organic acid.

It is also possible, after the application of the metallic coating, to perform a galvanic deposition of another metal from a corresponding galvanic bath, wherein the applied metallic coating serves as a crystal nucleus (in particular, irregularities on the coating).

The above-mentioned object with respect to the print head is met by the features of claim 27. Such a print head is provided for an overall device with which the method can be performed. The print head has a nozzle which is provided for ejecting the ink towards the surface of the substrate. In addition to the print head, an ink reservoir from which the print head is supplied with ink is part of the overall device. The ink contains a metal salt of an organic acid, which has the metal to be applied as a component. Furthermore, the print head can have means with which the surface of the plastic substrate or ceramic substrate can be roughened. In addition, the print head also has means with which energy can be supplied to the ink, and in such a way that a decomposition of the ink takes place as a result. Due to decomposition, the metallic coating is produced, which is intended to adhere to the surface, in particular the roughened surface, to produce the coating of the surface.

The same advantages arise with the print head as have been described previously in connection with the method. This also applies to the preferred embodiments of the print head described in the following.

The means for roughening the surface can have a laser and/or a plasma jet source and/or a fuel gas supply for generating a flame that contacts the surface. The underlying roughening mechanisms have been explained above in connection with the method.

Preferably, the print head has a heating unit with which the surface of the plastic substrate can be heated. In doing so, a rapid evaporation of a solvent used can be achieved. The intended temperature of the substrate surface can be 50° C. to 60° C. in particular.

The energy supply means for decomposing the ink can be arranged in such a way that the ink receives the energy after it is ejected from the nozzle, but before it impacts the surface. It can also be provided that the energy supply means are arranged in such a way that the ink receives the energy only after impacting the surface.

The energy supply means can have a fuel gas supply in connection with a fuel gas nozzle. Here, it is provided that a flame cone emerges from the fuel gas nozzle and comes into contact with the ink either on its way to the surface or on the surface. It has been found that the coating results are particularly good when the flame or flame cone is aligned at an acute angle to the substrate surface.

The energy supply means can also have a laser. One advantage of this is that the wavelength range of the emitted light can be well adapted to the absorption spectrum of the ink.

When using a laser for the decomposition of the ink or also, as described above, for roughening the surface, this does not have to be integrated into the print head, but the actual laser source can be part of the overall device and the print head can contain a mirror system or an optical waveguide with which the laser light is supplied to the surface or the ink.

Another possibility for the energy supply is to provide a plasma jet source. Furthermore, a source of heated process gas can also be provided with which energy is supplied to the ink to decompose it.

Preferably, the nozzle has an application lance having a movable nozzle tip. The advantages are described above in connection with the method.

The above-mentioned object regarding the use of a particular substance for coating is met by the features of claim 42. Here, the metal cation of the metal salt is converted to the elemental metal by energy supply and deposited in the form of the coating on the surface.

Preferred embodiments of the ink or use of the ink are recited in claims 43 and 44.

### BRIEF DESCRIPTION OF THE DRAWINGS

Embodiments of the invention will be explained in more detail with reference to the drawings.

FIG. 1 illustrates an inkjet print head with a laser and a plasma jet source,

FIG. 2 illustrates an inkjet print head with two lasers.

FIG. 3 illustrates an inkjet print head with a laser and a fuel gas supply,

FIG. 4 illustrates an inkjet print head with a plasma nozzle and a laser,

FIG. 5 illustrates an inkjet print head with a plasma nozzle and a fuel gas supply,

FIG. 6 illustrates a nozzle with a movable nozzle tip as part of an inkjet print head.

### DETAILED DESCRIPTION

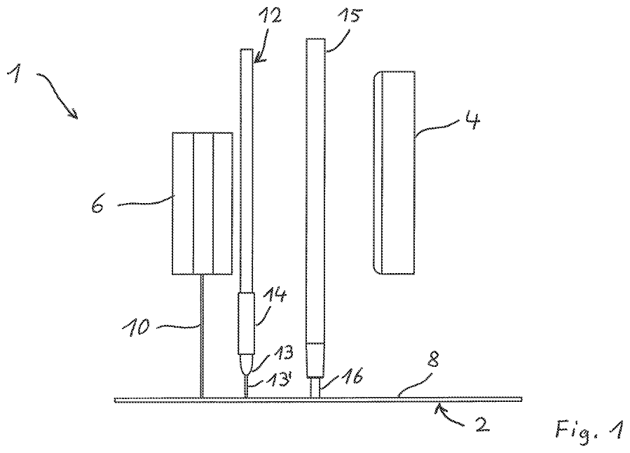

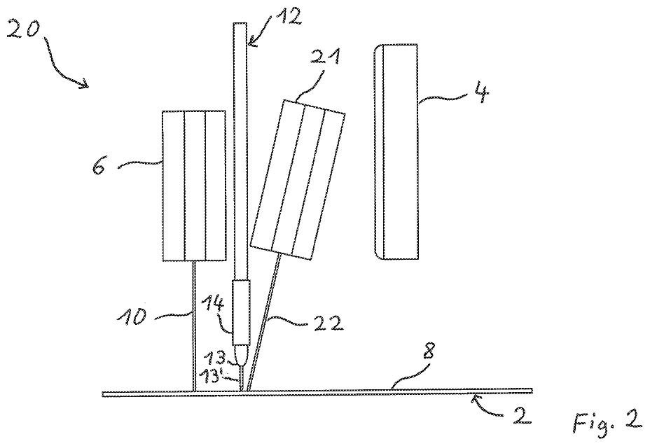

In the figures, the same parts are designated with the same reference signs. The inkjet print head shown in FIG. 1 is designated by the reference sign 1 and a component to be printed is designated by 2. The component 2, which is also shown in FIGS. 2 to 5, can be a printed circuit board, for example. The component 2 has a surface 8 to be processed made of a plastic and represents the plastic substrate.

The print head 1 has a holding device 4, which is shown only very schematically and can be, for example, a mounting flange. The holding device 4 is also shown in each case in FIGS. 2 to 6. Several components of the print head 1 are attached to the holding device 4.

Here, a laser 6 is used to pretreat the surface 8. The laser 6 specifically serves to roughen the surface 8 by guiding a light beam 10 of the laser 6 along the lines or areas of the surface 8 that are to be coated with a metal. Subsequently, a spray head 12 having a nozzle 13 from which ink is ejected in the form of an ink jet 13′ is guided over the roughened areas. The ink contains a salt of an organic acid, which in turn contains the metal to be applied, for example copper. For heating the ink, the spray head 12 has a heating jacket 14.

Furthermore, the print head 1 has a plasma nozzle 15 with which a plasma 16 can be directed onto the areas provided with ink. This causes a decomposition of the ink, in particular of the salt, so that the metal coating or the copper coating remains adhered to the surface 8 due to the roughening.

It is provided that the laser 6, the spray head 12 and the plasma nozzle 15 are moved accordingly over the surface 8 by the holding device 4. Alternatively, it would also be possible to move the component 2 accordingly relative to the holding device 4 and said components.

The inkjet print head according to FIG. 2 is designated by the reference sign 20. It differs from the inkjet print head 1 as follows. Instead of a plasma nozzle 15, the print head 20 has a further laser 21. Like the plasma nozzle 15, this serves to supply energy to the ink already applied to the surface 8 by the spray head 12. For this purpose, a light beam 22 can be directed obliquely, but it would also be possible to direct it perpendicularly, onto the areas provided with ink of the surface 8, so that a decomposition of the ink or salt also takes place here.

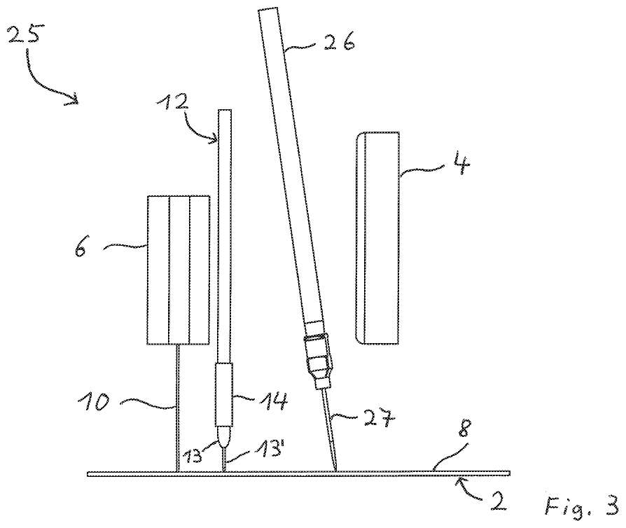

The inkjet print head according to FIG. 3 is designated by the reference sign 25. It differs from the inkjet print head 1 as follows. Instead of the plasma nozzle 15, the print head 25 has a fuel gas supply 26 with a fuel gas nozzle 27. These also serve to supply energy to the ink applied to the surface 8 in order to decompose it.

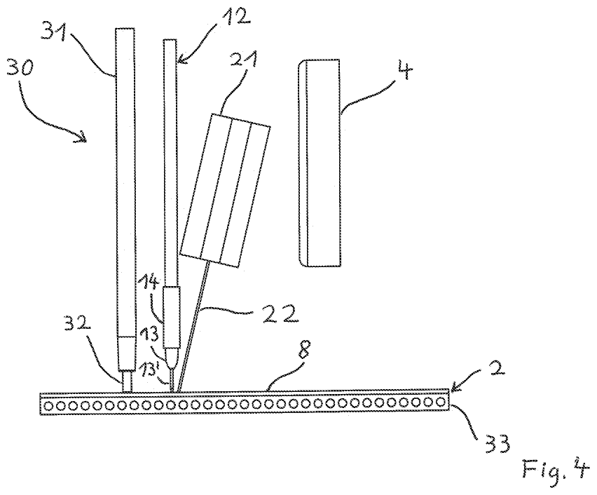

The inkjet print head according to FIG. 4 is designated by the reference sign 30. It differs from the inkjet print head 20 as follows: Instead of the laser 6, a plasma nozzle 31 is provided for roughening the surface 8 of the component 2, through which a plasma 32 can be brought into contact with the surface 8. In addition, the inkjet print head 30 has a heating unit 33 for heating the plastic substrate 2.

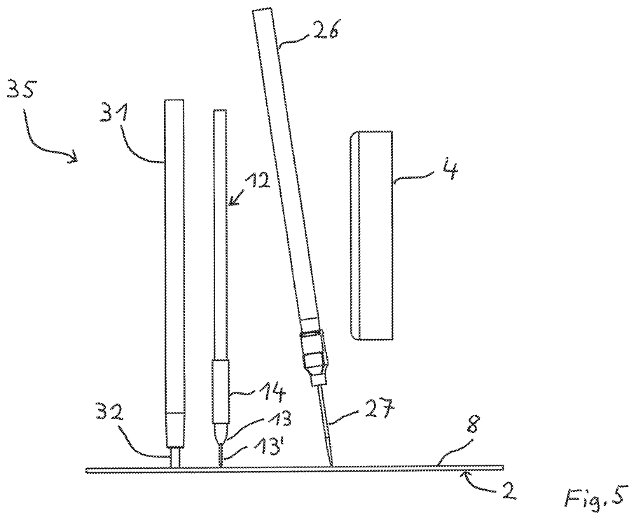

The inkjet print head according to FIG. 5 is designated by the reference sign 35. It differs from the inkjet print head 30 as follows: Instead of the laser 21, a fuel gas supply 26 with a fuel gas nozzle 27 is provided, through which a flame can be directed at the ink to supply energy to it and thereby achieve its decomposition.

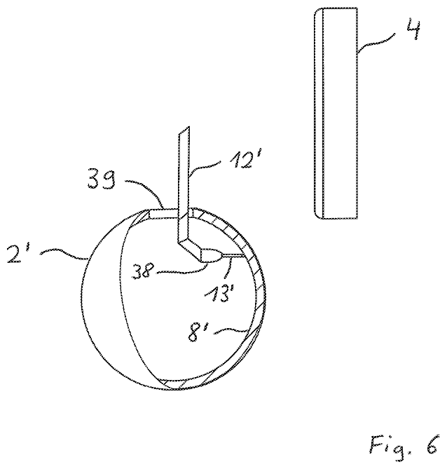

In FIG. 6, a hollow sphere 2′ is shown. It has an inner surface 8′ which is to be coated. For this purpose, an application lance 12′ is provided as part of an inkjet print head. The application lance 12′ can be attached directly to a holding device 4 or be part of a spray head attached to the latter. The application lance 12′ can be bent at several locations, and thus has a movable tip that constitutes a nozzle 38 from which ink can be ejected in the form of an inkjet 13′. Thus, with the application lance 12′, which has been inserted through an opening 39 of the hollow sphere 2′ to be closed later, it is possible to reach the entire inner surface for the purpose of coating with the movable nozzle 38.

According to an embodiment of the method, a plastic component made of polyamide (PA66) with a glass fiber content of 35% is first roughened by a suitable laser so that a microstructure containing material bridges is created. Then, ink in diluted form (5% copper neodecanoate (p, a.), 95% isopropanol (p, a.) is applied to the resulting roughness via an application nozzle. First, the structure is thus completely covered with the ink, and in a second pass the ink is decomposed by supplying energy, again by a laser. Subsequently, the component can be chemically copper-plated with respect to the microstructure.

In a further embodiment of the method, a plate of glass fiber-reinforced polyester resin is obliquely passed over with a hydrogen flame, i.e., at an acute angle to the surface, to roughen locations to be coated. Immediately afterwards, the ink (65% copper neodecanoate, 35% isopropanol) is applied to these locations and immediately decomposed by a second hydrogen flame, wherein a closed metallic layer with a thickness of 2-3 μm copper is deposited. The conductivities obtained here reach between 85% and 100% of the conductivity of non-chemically and non-galvanically deposited metallic copper.

1. A method for applying a metallic coating to a surface of a substrate, the method comprising:
applying an ink to a location to be coated of the surface the ink comprising at least one metal salt of an organic acid or a mixture of such salts; and
decomposing the ink by supplying energy to the ink, thereby generating the metallic coating from the metal salt or the metal salts, the metallic coating adhering to the surface at the location to be coated.

2. The method according to claim 1,
wherein the surface has a roughness at the location to be coated or is roughened to produce a roughness, and the metallic coating adheres to the location having the roughness, the roughening of the surface taking place before the ink is ejected.

3. The method according to claim 2,
wherein the surface is roughened by sand blasting or glass blasting or etching.

4. The method according to claim 1,
wherein the surface has a roughness at the location to be coated or is roughened to produce a roughness, and the metallic coating adheres to the location having the roughness, the roughening taking place during ejection of the ink.

5. The method according to claim 4,
wherein the roughening takes place by supplying energy using a laser.

6. The method according to claim 4,
wherein the roughening takes place by supplying energy while generating a plasma, the plasma simultaneously chemically activating the surface.

7. The method according to claim 4,
wherein the roughening takes place by supplying energy by a flame.

8. The method according to claim 1,
wherein the ink is ejected from a nozzle in a direction of the location to be coated.

9. The method according to claim 8,
wherein the ink is ejected in a form diluted by a solvent, and the nozzle causes fine atomization of the ink or ejects the ink in a form of droplets.

10. The method according to claim 9,
wherein a nonpolar or weakly polar organic solvent is used.

11. The method according to claim 10,
wherein the surface has a temperature of 50° C. to 60° C. during ink ejection or is heated to a temperature of 50° C. to 60° C.

12. The method according to claim 8,
wherein the ink is ejected in undiluted form, the ink is heated to a temperature below a decomposition temperature before reaching the nozzle or in the nozzle or between the nozzle and the surface and is finely atomized by the nozzle.

13. The method according to claim 8,
wherein the decomposing the ink takes place between the ejection from the nozzle and impact on the surface.

14. The method according to claim 1,
wherein the decomposing the ink takes place after impact on the surface.

15. The method according to claim 1,
wherein the decomposing takes place by supplying energy by a flame.

16. The method according to claim 15,
wherein the decomposing the ink takes place after impact on the surface, and the flame is at an acute angle with the surface.

17. The method according to claim 1,
wherein the decomposing takes place by supplying energy by electromagnetic radiation.

18. The method according to claim 1,
wherein the decomposing takes place by supplying energy by a plasma.

19. The method according to claim 1,
wherein the decomposing takes place by supplying energy by a heated process gas.

20. The method according to claim 8,
wherein the nozzle is a movable tip of an application lance.

21. The method according to claim 1,
wherein the at least one salt is a metal salt of a carboxylic acid or metal salts of a mixture of carboxylic acids.

22. The method according to claim 21,
wherein the at least one salt is a metal salt of neodecanoic acid.

23. The method according to claim 21,
wherein the metal salt is a copper salt.

24. The method of claim 23,
wherein the decomposing takes place by supplying energy by electromagnetic radiation having a wavelength of 620 nm to 850 nm.

25. The method according to claim 1,
wherein, after the adhering of the metallic coating, a chemical deposition of a further metallic coating takes place out from a galvanic bath without externally applied current to produce a desired metal layer composition on the surface, and the adhered metallic coating serves as a crystal nucleus.

26. The method according to claim 1,
wherein, after the adhering of the metallic coating, a galvanic deposition of a further metallic coating takes place out from an galvanic bath to produce a desired metal layer composition on the surface, and the adhered metallic coating serves as a crystal nucleus.

27. A print head for a device for performing the method according to claim 1, the print head comprising:
a nozzle configured to eject the ink towards the surface of the substrate and being fluidly connected to an ink reservoir of the device, and the ink having one or more salts of one or more organic acids, each salt of the a least one salt containing a coating-forming metal to be applied; and
means for supplying energy to the ink so that the decomposing of the ink takes place and the metallic coating produced thereby remains adhered to the surface at the location to be coated.

28. The print head according to claim 27,
further comprising means (6; 31) for roughening the surface at the location to be coated of the substrate, so that the metallic coating produced remains adhered to the surface at the locations having a roughness.

29. The print head according to claim 28,
wherein the means for roughening the surface includes a laser (6).

30. The print head according to claim 28,
wherein the means for roughening the surface includes a plasma jet source.

31. The print head according to claim 28,
wherein the means for roughening the surface includes a fuel gas supply configured to generate a flame to contact the surface.

32. The print head according to claim 27,
further comprising a heating unit to heat the surface of the substrate.

33. The print head according to claim 27,
wherein the means for supplying energy is arranged such that energy supply takes place after the ink has been ejected and before the ink impacts the surface.

34. The print head according claim 27,
wherein the means for supplying energy is arranged such that energy supply takes place after the ink has impacted the surface.

35. The print head according to claim 27,
wherein the means for supplying energy includes a fuel gas supply and a fuel gas nozzle.

36. The print head according to claim 35,
wherein the fuel gas nozzle is arranged at an acute angle adjacent to the surface of the substrate.

37. The print head according to claim 27,
wherein the means for supplying energy includes a laser.

38. The print head according to claim 27,
wherein the means for supplying energy a plasma jet source.

39. The print head according to claim 27,
wherein the means for supplying energy includes a source of heated process gas.

40. The print head according to claim 27,
further comprising an application lance with a movable nozzle (38).

41. The print head according to claim 27,
wherein the nozzle is part of a spray head which has a heating jacket configured to heat the ink upstream of the nozzle in a direction of flow.

42. An ink for applying a metallic coating to a surface of a substrate, a method according to claim 1, comprising:
the at least one metal salt of an organic acid or a mixture of such salts, the at least one metal salt configured to form the metallic coating on the surface when supplied with energy.

43. The ink according to claim 42,
wherein the organic acid is a carboxylic acid or a mixture of carboxylic acids.

44. The ink according to claim 42,
wherein the at least one metal salt is a copper salt.
